(19) United States
(12) Patent Application Publication
(10) Pub. No.: US 2010/0153695 A1
(43) Pub. Date: Jun. 17, 2010

(54) DATA HANDLING PREFERENCES AND POLICIES WITHIN SECURITY POLICY ASSERTION LANGUAGE

(75) Inventors: Laurent Bussard, Venviers (BE); Moritz Y. Becker, Cambridge (GB)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/336,349

(22) Filed: Dec. 16, 2008

(51) Int. Cl. G06F 9/00; G06F 21/00

(52) U.S. Cl. 713/1; 726/4; 726/1

(57) ABSTRACT

Whether user-side privacy preferences and service-side privacy policies are matched is determined utilizing an extended security policy assertion language. Both privacy policies, i.e. how data recipients promise to treat data, and privacy preferences, i.e. how data providers expect their data to be treated, are expressed with the same language. Decisions are made through evaluation of queries based on preference and policy assertions.

### BACKGROUND

In many networked applications (advertisement, search, e-health, travel booking, etc.), data are collected and stored by service providers. Those data are often personal data such as e-mail address, name, credit card number, IP address. The data may even include medical data, financial data, preferences, family pictures, and similar information. Personal data or a subset of it is also referred to as Personally Identifiable Information (PII). In such systems, data owners need to convey their preferences regarding handling of their data to components of the system that processes or stored the data. For example, preferences may express that an e-mail address cannot be used for advertisement, must be deleted after six months, or cannot be handed out of a given jurisdiction/trust domain. The data owners or users may also desire to know how data recipients plan to handle their data.

While attempts to address privacy protection and security concerns of users have been made in a variety of ways, some of those provide only service-side policies leaving it to users to parse those policies. Other approaches define lists of hierarchies of data-categories, user-categories, purposes, sets of (privacy) actions, obligations, and conditions. These elements are then used to formulate privacy authorization rules that allow or deny actions on data-categories by user-categories for certain purposes under certain conditions while mandating certain obligations. None of these mechanisms provide an efficient and comprehensive solution for online service related privacy concerns. Moreover, existing mechanisms lack formalism to analyze preferences and policies.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to verifying whether user-side privacy preferences and service-side privacy policies match utilizing a security policy assertion language. Decisions may be made based on the verification whether Personally Identifiable Information can be provided to a service.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example environment where personal data may be exchanged between a user and services subject to service policies and user preferences;

FIG. 2 illustrates an example set of user preferences and corresponding service policies that may be matched according to embodiments;

FIG. 3 is an action diagram illustrating actions and interactions between a user and services implementing personal data handling according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for handling personal data based on user preferences and service policies according to embodiments.

### DETAILED DESCRIPTION

As briefly described above, user-side privacy preferences and service-side privacy policies may be evaluated to determine whether they match utilizing security policy assertion language queries, and users notified such that they can determine if they can provide their personal information to a particular service or not. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, references are made to services. A service as used herein describes any networked/on line application(s) that may receive a user's personal information as part of its regular operations and process/store/forward that information. Such application(s) may be executed on a single computing device, on multiple computing devices in a distributed manner, and so on. Embodiments may also be implemented in a hosted service executed over a plurality of servers or comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

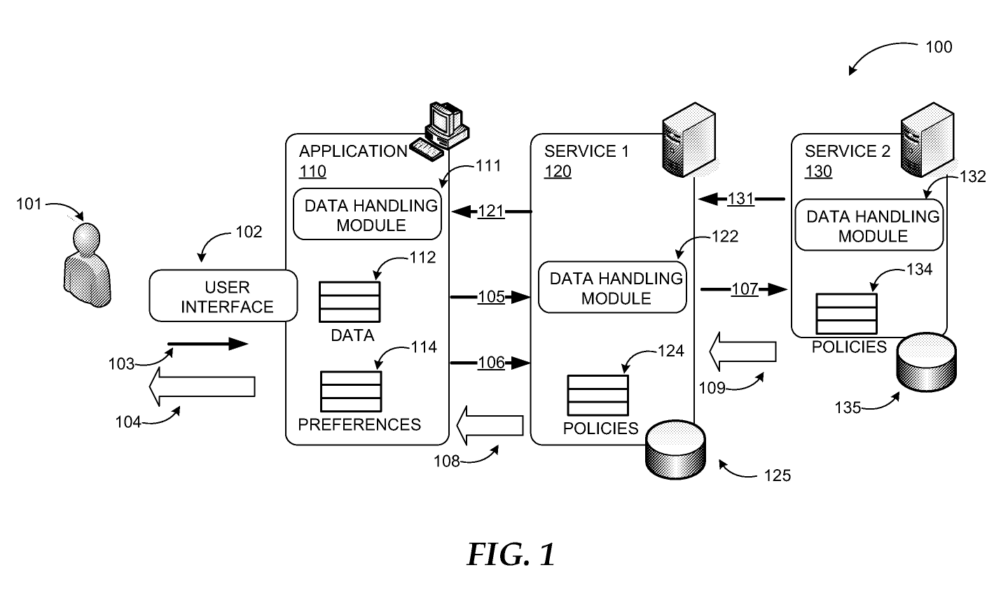

Referring to FIG. 1, conceptual diagram 100 illustrates an example environment where personal data may be exchanged between a user and services subject to service policies and user preferences. As briefly mentioned before, privacy protection and security concerns of users are addressed in various ways. For example, the Platform for Privacy Preferences Project (P3P) allows web sites to state their privacy policy, i.e. how they intend to use collected information. P3P only defines service-side policies, lets user agents parse the policy, and compare the parsed policy with user preferences. Different languages such as APPEL, XPref, PREP, are used to define preferences. The privacy policy specifies the type of information that is collected and stored by the service (e-mail address, name, etc.), how collected data is used (personalization, advertisement, etc.), whether collected data is shared with third parties, how long the information is stored, and whether the user can access stored data. However, P3P lacks a formal description of policies and preferences. As a result, a service provider needs other mechanisms to verify that it does not break its policy. P3P further lacks expressiveness to describe properties of third parties with which data is shared.

Another approach is Enterprise Privacy Authorization Language (EPAL), a formal language to specify enterprise-internal privacy policies. An EPAL policy defines lists of hierarchies of data-categories, user-categories, purposes, sets of (privacy) actions, obligations, and conditions. These elements are then used to formulate privacy authorization rules that allow or deny actions on data-categories by user-categories for certain purposes under certain conditions while mandating certain obligations. EPAL focuses on the enforcement of privacy policies within a single trust domain where purpose, conditions, obligations, data categories, and user categories are centrally defined. As a result, it does not enable express disclosure of data to a third party.

Yet another example mechanism is eXtensible Rights Markup Language (XrML), a language to express digital rights for content and services. In XrML, a right is expressed as a “verb” that a principal can be granted to exercise against some resource under some condition. Licenses contain a set of rights, the identification of the principal issuing the license, and additional information such as validity date. XrML, however, lacks a precise way to describe properties of third parties with which data is shared. Furthermore, XrML does not address obligations, but only actions and conditions.

A system according to some embodiments is directed to processing the data-handling preferences and policies expressed as assertions and queries. Such a system may rely on and extend an existing language with a formal semantics, such as SecPAL. The security policy language's key features such as its syntactic and semantic format, policy expressiveness, and execution efficiency may be inherited and expanded upon. The syntax of the example SecPAL is close to natural language, and the semantics consists of few deduction rules. The language can express many common policy idioms using constraints, controlled delegation, recursive predicates, and negated queries. Because the language has a formal semantics, it is possible to reason about preferences and policies in order to verify properties and find missing assertions.

Obligations are defined in SecPAL with specific types of assertions letting parties specify required obligations, supported obligations, and commitment to enforce specific obligations. Some data-handling languages (e.g. P3P, XrML) do not address obligations at all. Other languages (e.g. XACML, EPAL) offer a place holder for obligations without specifying obligations. An extended security and privacy handling language according to embodiments enables reasoning on obligations.

Furthermore, such a language can express preferences and policies regarding data forwarding to third parties. This enables more control on data transfer. The language also makes it possible to express statements on data handling policies of another party in a separate administrative domain (i.e. outside the scope of the organization's service/website).

In diagram 100, user 101 interacts with a service 1 (120) through the user interface 102 of application 110. Service 1 (120) may be any networked or online service such as a travel booking service, a financial transactions service, a healthcare transactions service, a library related service, or any similar service. In a typical encounter, user 101 provides a request for a particular service. In a system implementing embodiments, user 101 may also provide their preferences regarding the use of their personal data. Thus, application 110 acting as the user agent of service 1 (120) may receive/handle personal data 112 and user preferences 114.

Personal data 112 as well as particulars of the requested service and user preferences 114 may be forwarded to service 1 (120) separately (105, 106) or together. Prior to forwarding of the user's personal data (103), data handling module 111 of application 110 may determine whether there is a match between the received user preferences 114 and service policies 124 using assertions and queries in form of an extended security assertion language as described in more detail below. If the user preferences and the service policies match, the user personal data may be provided to the service 120 through application 110 (108 and 104). To perform the check, application 110 may receive service policies 124 from service 1 (120) as represented by arrow 121.

User's interaction with an online service may actually involve multiple services. For example, a user purchasing a particular item at an online store may actually buy that item from a separate seller through the online store. Thus, services with differing personal data policies may forward user data to each other. Service 2 (130) with its policies 134 in diagram 100 is an example of such a secondary service. As part of processing user request, service 1 (120) may have to request auxiliary services from service 2 (130) sending it user data (107) and receiving the requested auxiliary service 109 before combining it with its own service and forwarding to the user (108). In such a scenario, the policies of service 1 (124) may first be combined with the policies of service 2 (134) and then evaluated against the user preferences such that a match is determined between the user preferences 114 and combined policies (124 and 134) again using assertions and queries. To determine a match, service 2 (130) may send its policies 134 to service 1 (120) as represented by arrow 131, which in return may send the combined policies 124 and 134 to application 110 as represented by arrow 121. Data stores 125 and 135 are shown in conjunction with services 120 and 130 to illustrate that user data may be collected and stored by each service.

The data handling language described herein may be used with different settings ranging from purely service-driven scenarios (like P3P) to user-driven scenarios (like “sticky policies”). In a service-driven scenario, the user gets a static policy describing how the service (and potential third parties) will handle his/her personal data. The user checks that his/her preferences match the policy and provide the personal data to the service. The service knows the static policy that must be enforced and ensures that no operation violating the policy can happen. The main advantages of such scenarios are simplicity and efficiency since the policy is only evaluated once.

In more dynamic scenarios, the user may personalize policies to make sure that specific personal data is treated appropriately. In this case, part of the preferences has to be sent to the service with the personal data. Moreover, a service may collect personal data through different mechanisms with different policies (purpose, obligations, etc.) and store them together. As a result, it may be necessary to have policies associated to one or more personal data. Such policies are referred to as being attached to personal data as “sticky policies”. In this latter case, before using personal data, the service must check that it is allowed by relevant policies to do so. Flexibility has a computational cost that may be overwhelming when policy evaluation is required before any action on personal data. Grouping personal data with common policies as well as caching policy evaluation results may be used to improve performances when flexibility is necessary.

Security Assertions Policy Language (SecPAL) has been discussed above as an example language that may be extended to implement PII handling according to embodiments. Embodiments are not limited to SecPAL extensions however. Any language with formal semantics that enable reasoning about preferences and policies in order to verify properties and find missing assertions can be used to implement embodiments. Moreover, services that may take advantage of a data handling system according to embodiments are not limited to the examples discussed above. Any networked service interacting with users and receiving user data may implement embodiments using the principles discussed herein.

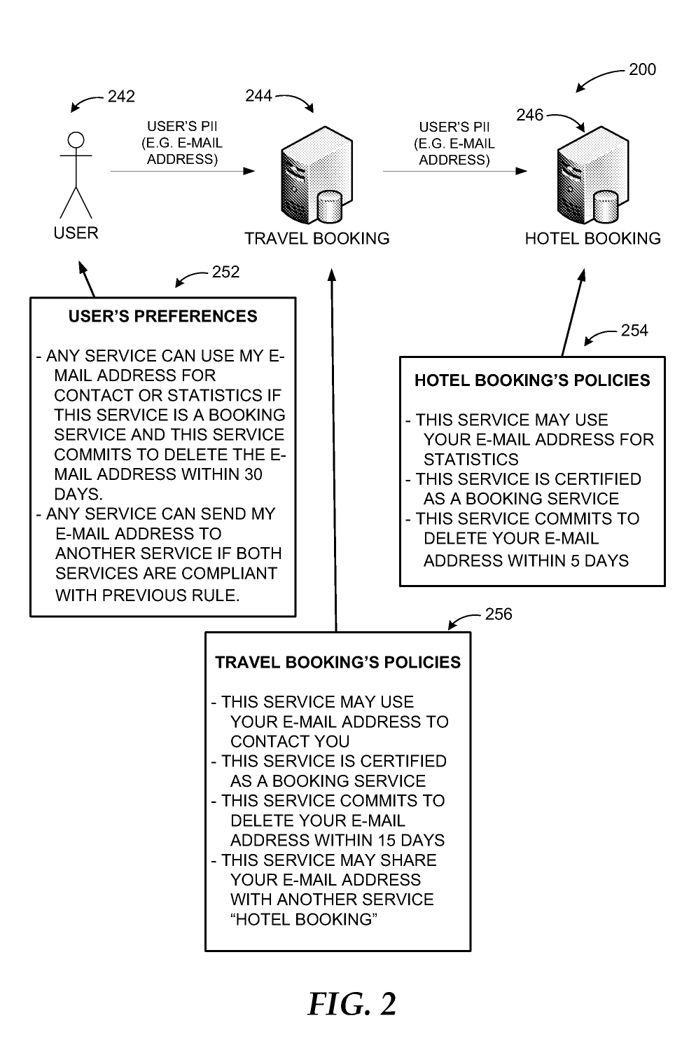

FIG. 2 illustrates an example set of user preferences and corresponding service policies that may be matched according to embodiments. Pseudo assertions are used to describe the preferences and policies. Concrete assertion language is defined below. A travel booking service 244 is an example hosted service where user PII such as email address, physical address, telephone number, and similar information may be received, processed, and even forwarded to other services (e.g. hotel booking service 246) by the service. The interaction between services may be based on coordination of services, user requests, apportionment of service types, and comparable reasons. In the example of diagram 200, travel booking service 244 is used by user 242 to make reservations for travel packages, which may include flights, hotel accommodations, car rentals, and so on. Travel booking service 244 may rely on hotel booking service 246 for the hotel reservation portion of the travel related services.

In the example scenario, user 242 specifies how her PII is to be used in their preferences 252. The preferences may include: (a) any service that gets user's email address can use this address to contact her and for statistics if the service is certified as a booking service and if the service commits to delete the address within one month; and (b) any service that gets user's email address can send this address to another service if this one can use the email address according to the first rule.

While travel booking service 244 may have a large number of policies for dealing with user information (and other information for that matter), the policies (256) relevant to the user PII as specified in the user preferences 252 may include: (c) travel booking is collecting e-mail addresses and may use them to contact users when the booking is done or cancelled; (d) travel booking is certified as a booking service by a given trusted third party; (e) travel booking service commits to deleting e-mail within two weeks; and (f) travel booking may share users' email with another service: hotel booking.

Hotel booking service 246 may have its own policies 254: (g) hotel booking is collecting e-mail addresses and may use them for statistics; (h) hotel booking is certified as a Booking Service by a trusted third party; and (i) hotel booking commits to deleting email within five days.

When user 242 has to provide some PII (e.g. her email address) to travel booking service 244, her “user agent” may receive the policy of the service and verify that it matches user's preferences. According to other embodiments, the matching may also be performed at the service or by a third party and user 242 informed about the results. The matching process is independent of any protocols that may be used to exchange data and policies (HTTP, SOAP or REST web services, Metadata Exchange, and comparable ones). At first step the preferences and policies are converted to (if not already in that form) assertions.

If only assertions (a) through (e) existed, the following reasoning may have been applied: First, a query is created from (c): “Does user let travel booking use her email address for contact?” Next this query is evaluated with all existing assertions, i.e. (a)-(e). The response is “yes” because (d) states that travel booking is a booking service, (e) states that travel booking will delete email within two weeks, and (a) states that user let any service, which is a booking service and commits to delete email within a month, can use her email address.

Similar reasoning may be applied to hotel booking when assertions (f) through (i) exist. There are, however, two possible cases: According to a first possibility, all assertions are known by the user, i.e. the policy provided by travel booking service contains a reference to the policy of hotel booking and both are obtained by the user. In this case, the three queries “Does user let travel booking use her email address for contact?”, “Does user let travel booking send her email address to hotel booking?”, and “Does user let hotel booking use her email address for statistics?” may be evaluated by the user's agent. According to a second possibility, some assertions cannot be known by the user. In some dynamic scenarios where the third party (e.g. hotel booking) is not known when user hands data over to travel booking, part of the queries may be run by travel booking when it hands over data to hotel booking. This may lead to an interaction with user when some assertions are missing.

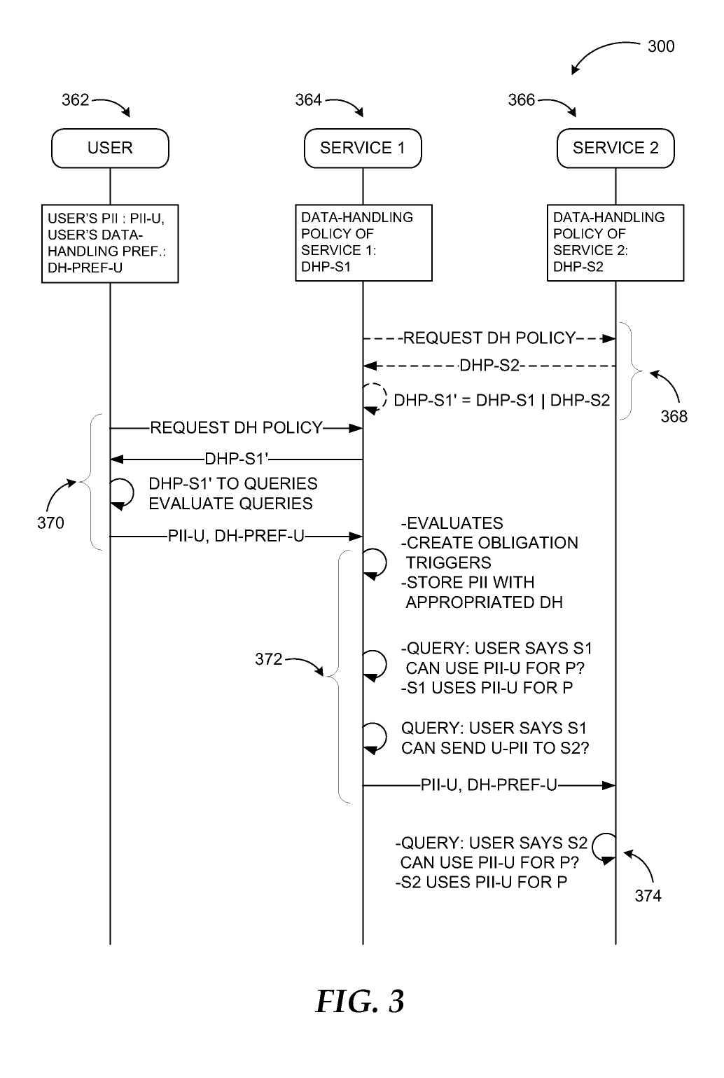

FIG. 3 is an action diagram illustrating actions and interactions between a user and services implementing personal data handling according to embodiments. Diagram 300 provides an overview of the distributed enforcement of the data handling queries. In steps 368, the data handling policy of a secondary service (Service 2) 366 is retrieved and merged with the policy of the primary service (Service 1) 364. It should be noted that steps 368 may be postponed after “storage of PII with appropriate Data Handler (DH)” step when the secondary service 366 is dynamically selected. This has a slight impact on the data handling policy of the primary service 364. At the beginning of the interaction between user 362 and primary service 364 (steps 370), the data-handling policy of the primary service (potentially including secondary policies) is provided to the user. This is followed by the policy being transformed on queries (may [symbol] can?) that are evaluated with user preferences and assertions provided by service(s) (364, 366). If all queries succeed, at the last step of 370, PII and preferences are sent to the primary service 364. Each time service 364 needs to use or send PII, a query is locally evaluated to verify that this is an authorized action as shown in steps 372. Similarly service 366 may evaluate a query before using PII as shown in steps 374.

A security assertion language with extended capabilities to evaluate and match user preferences and service policies (e.g. expanded SecPAL) may include verb phrases <VP> modified by modal verb phrases <MVP>:

<VerbPhrase> ::=
<AVP>
<MVP>
can say <VerbPhrase>
can say0 <VerbPhrase>
can act as <Principal>

<AVP> stands for auxiliary, application-specific verb phrases without built-in semantics (e.g., possesses). These may be defined to take any fixed number of expressions as parameters. Expressions (such as principals, PII-types, usage purposes, numbers, strings, etc) may be values or variables. Modal verb phrases <MVP> may be defined using the four special modal verbs can, may, must and will:

<MVP> ::=
can <DataAction>
may <DataAction>
must <DataAction>
will <DataAction>

Data-handling specific actions <DataAction> may be defined as follows:

<DataAction> ::=
send <PIIType> to <Principal>
use <PIIType> for <Purpose>
delete <PIIType> within <Duration>

Data-handling actions are not restricted to the examples listed above. Other actions with no built-in semantics may be added, as long as the first parameter is a PII-type, using the principles described herein. Of the ones above, only send has a special semantics; the other two are only exemplary. The assumption is made that send is the only action that can cause a PII to be forwarded from one service to another. Given a particular PII-type D, a D-action is a data-handling action with D as its first parameter.

An extended language capable of evaluating user preferences and service policies according to embodiments may include in its grammar:
<Fact>::=<Principal><VP>,
   which may be combined to form assertions of the form:
<Assertion>::=<Principal> says <Fact> if <Fact1>, . . . , <FactN> where <C>.

Here, the first parameter is the issuer of the assertion. The fact after says is the conclusion fact, and the facts inside the if-clause are the conditional facts. <C> stands for application-specific constraints on variables occurring in the assertion and environmental values (e.g. the current time). These constraints may include regular expression constraints and inequality constraints, and may be combined to form more complex constraints using Boolean conjunction, disjunction, and negation. If N, the number of conditional facts, is 0, the if-clause can be omitted. Similarly, if the constraint is simply true, the entire where-clause may be omitted.

The semantics may be defined in terms of four proof rules that inductively define judgments of the form:
AC ├ A says <Fact>,

where AC is an assertion context, i.e., a set of assertions, and A says fact is ground (variable-free). In the following, θ is a variable substitution, i.e., a partial map from variables to expressions, and A, B, S, T, U are (meta-variables for) ground principal names (e.g. users and services). The four rules may be defined as follows:

$$( cond ) \frac{\begin{matrix}A C ⊢ θ ( A says < Fact 1 > ) … \\ A C ⊢ θ ( A says < Fact N > )\end{matrix}}{A C ⊢ θ ( A says < Fact > )} \qquad [ 1 ]$$

provided that (A says <Fact> if <Fact1>, . . . , <FactN> where <C>) ∈ AC, and θ(<C>) is ground and valid, and θ(A says <Fact>) is ground. This rule states that the concluding fact can be proven (for some variable instantiation) if a matching assertion exists in the assertion context such that the issuer A also provably says all conditional facts (under the same variable instantiation) and such that the constraint is true.

$$( can say ) \frac{\begin{matrix}A C ⊢ A says B can say \\ < Fact > A C ⊢ B says < Fact >\end{matrix}}{A C ⊢ A says < Fact >} \qquad [ 2 ]$$

The rule [2] defines the semantics of can say, where principal A delegates authority over some fact to B.

$$( can say 0 ) \frac{\begin{matrix}A C ⊢ A says B can say 0 < Fact > \\ AC\_B ⊢ B says < Fact >\end{matrix}}{A C ⊢ A says < Fact >} , \qquad [ 3 ]$$

where AC_B consists of only those assertions in AC that are issued by B. This rule defines the semantics of can say0: A delegates authority over some fact to B, but does not allow B to re-delegate this delegation authority further.

$$( can act as ) \frac{\begin{matrix}A C ⊢ A says B can act as C \\ A C ⊢ A says C < VerbPhrase >\end{matrix}}{A C ⊢ A says B < VerbPhrase >} . \qquad [ 4 ]$$

The rule [4] defines the semantics of can act as. Essentially, if B can act as C, then whenever some verb phrase applies to C, then it also applies to B. These four rules may be extended by two additional proof rules defining subsumptive relationships between the modal verbs in a system according to embodiments:

$$( will \text{-} may ) \frac{A C ⊢ A says B will < VerbPhrase >}{A C ⊢ A says B may < VerbPhrase >} , and \qquad [ 5 ]$$

$$( must \text{-} can ) \frac{A C ⊢ A says B must < VerbPhrase >}{A C ⊢ A says B can < VerbPhrase >} . \qquad [ 6 ]$$

A user U's preference may be specified as a set of assertions AC(U). Given a user U, a service T and a PII-type D, the can-actions Can(AC, U, T, D) may be defined as the set of all D-actions DA such that AC ├ U says T can DA. The must-actions Must(AC, U, T, D) be defined as the set of all D-actions DA such that AC ├ U says T must DA. It should be noted that Must(AC, U, T, D) is a subset of Can(AC,U,T,D), due to the proof rule (must-can). A service T complies with a user U's preference on PII-type D with respect to AC if and only if the set of data-handling actions it performs on D is a subset of Can(AC, U, T, D) and a superset of Must(AC, U, T, D).

As mentioned previously, in addition to the user preferences, a service's data-handling policy may also be specified as a set of assertions. For a particular data-handling policy AC, a service T, and a PII-type D, the may-actions May(AC, T, D) can be defined as the set of all D-actions DA such that AC ├ T says T may DA. The will-actions Will(AC, T, D) can be defined as the set of all D-actions DA such that AC ├ T says T will DA. It should be noted that Will(AC, T, D) is a subset of May(AC, T, D), due to the proof rule (will-may). Thus, a service T complies with a data-handling policy AC on PII-type D if the set of data-handling actions it performs on D are a subset of May(AC, T, D) and a superset of Will(AC, T, D).

In the context of a data-handling interaction between a service S and a user regarding a PII-type D, it can be assumed that S knows a priori the set FS(S, D) consisting of S itself as well as all other services that may eventually get hold of D as a result of that interaction, because there is a potential forwarding path from S to those services. Furthermore, it can be assumed that S has access to the data-handling policies of each service in FS(S, D). These policies may either be cached or fetched at evaluation time. The combined policy AC(S, D) of S is the union of all these policies. Let A→B be short for AC (S, D)├ A says A may send D to B, and let→* denote the transitive-reflexive closure of the relation →. Relevant services, RS, may then be defined as the set of all principal services T such that S→*T. If all relevant services, RS, comply with AC(S, D), then D is not forwarded to any party outside RS(S, D) as a result of the interaction between the user and S.

For a particular data-handling interaction consisting of a user U, a PII-type D, and a service S, S's combined policy AC(S, D) matches U's preferences on D if and only if for all services T in RS(S, D) the following holds:
May(AC(S,D),T,D) [symbol] Can(AC(U)∪AC(S,D),U,T,D) and
Must(AC(U)∪AC(S,D),U,T,D) [symbol] Will(AC(S,D),T,D).
   The main property of this approach is as follows: if S's combined policy matches U's preferences on D (this can be checked statically) and if all relevant services comply with AC(S, D) (this can be assumed), then all relevant services also comply with U's preference on D with respect to AC(S, D).

Referring back to the example scenario discussed in FIG. 2, using the rules described above, the user's preferences in that scenario may be expressed as:
AL.1) User says $x can use Email for Contact if
   $x is a BookingService,
   $x will delete Email within $d
where
   $d<=30 days
AL.2) User says $x can use Email for Pseudonymous-analysis if
   $x is a BookingService,
   $x will delete Email within $d
where
   $d <=30 days
AL.3) User says $x can send Email to $y if
   $x is a BookingService,
   $y is a BookingService,
   $y will delete Email within $d
where
$d <=15 days
AL.4) User says TTP can say0 y is a BookingService
AL.5) User says $x must delete Email within 30 days if $x is a BookingService
AL.6) User says $x can say0 $x may use Email for $p if $x is a BookingService
AL.7) User says $x can say0 $x will delete Email within $d if $x is a BookingService
AL.8) User says $x can say0 $x may send Email to $y if $x is a BookingService.

Similarly, using the rules described above, the travel booking service's policies in that scenario may be expressed as:
TB.1) TravelBooking says TravelBooking may use Email for Contact
TB.2) TravelBooking says TravelBooking may use Email for Pseudonymous-analysis
TB.3) TravelBooking says TravelBooking may send Email to HotelBooking
TB.4) TTP says TravelBooking is a BookingService
TB.5) TravelBooking says TravelBooking will delete Email within 30 days

The hotel booking service's policies in that scenario may be expressed as:
HB.1) TTP says HotelBooking is a BookingService
HB.2) HotelBooking says HotelBooking may use Email for Contact
HB.3) HotelBooking says HotelBooking will delete Email within 30 days.

In the course of the interaction with the user, TravelBooking may forward the address to HotelBooking, but to no one else. Hence FS(TravelBooking, Email) consists of TravelBooking and HotelBooking and the combined policy ACS def AC(TravelBooking, Email) ∪ AC(HotelBooking, Email) consists of the assertions TB.* and HB.*.

First, RS(TravelBooking, Email) may be computed; this may be done by evaluating queries of the form “T says T may send Email to $x?” against ACS, where the value for T is TravelBooking in the first step, then in the second step the return values for $x etc., iterating until a fixed point is reached. In this case: RS(TravelBooking,Email)={TravelBooking, HotelBooking}, because of TB.3.

Next, to compute May(ACS,T,Email), queries of the form “T says T may DA?” are evaluated against ACS, for T in {TravelBooking, HotelBooking} and all Email-actions DA occurring in ACS. The evaluation of the above queries may be performed by any party who has access to ACS. The results are as follows:
[7] May(ACS,TravelBooking, Email)={(1) use Email for Contact, (2) use Email for Pseudonymous-analysis, (3) send Email to HotelBooking, (4) delete Email within 30 days}, and
[8] May(ACS,HotelBooking, Email)={(5) use Email for Contact, (6) delete Email within 30 days}.

If AC is the union of all assertions from this scenario (i.e., AC is the union of ACS and assertions AL.*). For each Email-action in a May set, whether the Email-action is also in the corresponding can-set needs to be verified by evaluating AC. The corresponding query evaluations may be performed by any party who has access to AC. Thus, the matches for the assertions and policies are:
(1) matches, because AC ├ User says TravelBooking can use Email for Contact is derivable. This derivation follows from AL.1, AL.4, TB.4, AL.7, and TB.5.
(2) matches, because AC ├ User says TravelBooking can use Email for Pseudonymous-analysis is derivable. This derivation follows from AL.2, AL.4, TB.4, AL.7, and TB.5.
(3) matches, because AC ├ User says TravelBooking can send Email to HotelBooking is derivable. This derivation follows from AL.3, AL.4, TB.4, HB.1, AL.7, and HB.3.
(4) matches, because AC ├ User says TravelBooking can delete Email within 30 days is derivable. This derivation follows from AL.5.
(5) matches, because AC ├ User says HotelBooking can use Email for Contact is derivable. This derivation follows from AL.1, AL.4, HB.1, AL.7, and HB.3.
(6) matches, because AC F User says HotelBooking can delete Email within 30 days is derivable. This derivation follows from AL.5.

Next, to compute Must(AC, User, T, Email), queries of the form “User says T must DA?” are evaluated against AC, for T in {TravelBooking, HotelBooking} and all Email-actions DA occurring in AC. The results are as follows:
[9] Must(AC, User, TravelBooking, Email)=Must(AC, User, HotelBooking, Email)={delete Email within 30 days}.

For each Email-action in a must-set, whether the Email-action set is also in the corresponding will-set needs to be verified. The corresponding query evaluations can be performed by any party who has access to ACS. In the above example, the verification is successful because ACS ├ TravelBooking says TravelBooking will delete Email within 30 days. ACS ├ HotelBooking says HotelBooking will delete Email within 30 days are both derivable, because of TB.5 and HB.3. Following are, therefore, established for both T in {TravelBooking, HotelBooking}:
[10] May(ACS, T, Email) [symbol] Can(AC, User, T, Email) and
[11] Must(AC, User, T, Email) [symbol] Will(ACS, T, Email).

Hence TravelBooking's combined policy matches User's preferences on Email, and by the main correctness property of this approach, TravelBooking is guaranteed to comply with User's preferences, so User can safely give her email address to TravelBooking, provided she trusts all involved service to comply with their combined policy.

While specific operations, grammar, syntax, and rules have been discussed in the example scenarios and matching of user preferences and service policies in conjunction with FIG. 3, embodiments are not limited to those. Evaluation of data handling preferences and policies may be implemented employing other operations, grammar, syntax, rules, and so on, using the principles discussed herein.

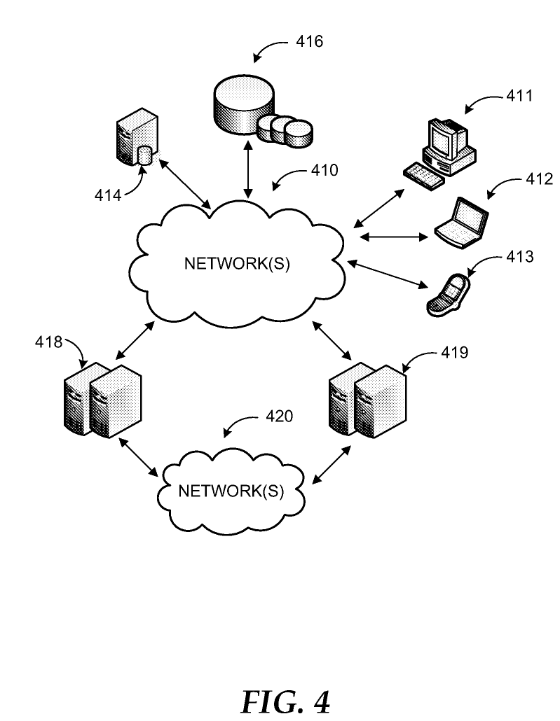

FIG. 4 is an example networked environment, where embodiments may be implemented. An extended security assertions language capable of enabling data handling preference and policy evaluation through queries may be implemented via software executed over one or more servers 418 such as a hosted service. The server 418 may communicate with client applications on individual computing devices such as a smart phone 413, a laptop computer 412, and desktop computer 411 (client devices) through network(s) 410. Client applications on client devices 411-413 may facilitate user interactions with the service executed on server(s) 418 enabling a user to request particular services and provide PII associated with the requested service(s). The preference—policy matching evaluations discussed above may also be implemented by the client applications or user agents associated with the client applications. Furthermore, the service executed on server(s) 418 may interact with another service executed on server(s) 419 in providing a portion of the user requested services. Server(s) 418 and 419 may communicate through network(s) 410 and/or network(s) 420. At least a portion of the preference—policy matching evaluations discussed above may further be implemented by the service(s) executed on server(s) 419.

Data associated with the operations such as user PII may be stored in one or more data stores (e.g. data store 416), which may be managed by any one of the server(s) 418, 419 or by database server 414. Personal data handling policy evaluation according to embodiments may be triggered when the data is used by a user agent or sent to a third party as discussed in the above examples. However, such an evaluation may also be enforced by a database storing personal data. For example, database server 414 may enforce the verification of attached policy before allowing a specific action (e.g. read) on the personal data stored in any of the data stores managed by the database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a system for evaluating user preferences against service policies according to embodiments. Furthermore, the networked environments discussed in FIG. 4 are for illustration purposes only. Embodiments are not limited to the example applications, modules, or processes.

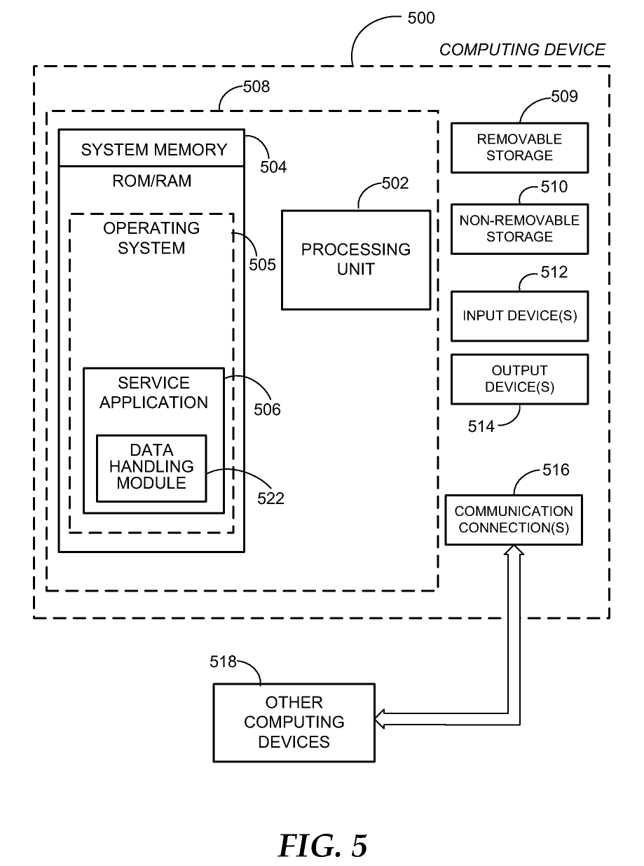

FIG. 5 and the associated discussion are intended to provide a brief, general description of a suitable computing environment in which embodiments may be implemented. With reference to FIG. 5, a block diagram of an example computing operating environment for a service application according to embodiments is illustrated, such as computing device 500. In a basic configuration, computing device 500 may be a server in a hosted service system and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as service application 506 and data handling module 522.

Data handling module 522 may be a separate application or an integral module of a hosted service that handles user data as discussed above. Evaluation of user preferences and service policies may be performed by utilizing queries based on preference and policy assertions. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute applications enabling users to input new data/requests, modify existing data/requests, and comparable operations. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

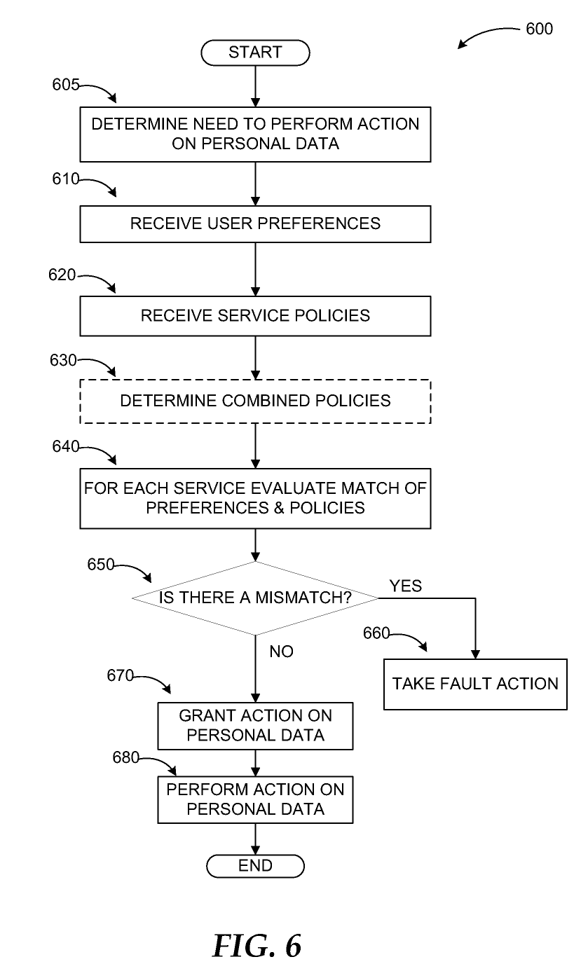

FIG. 6 illustrates a logic flow diagram 600 for handling personal data based on user preferences and service policies according to embodiments. Process 600 may be implemented at a server as part of a hosted service or at a client application for interacting with a service such as the ones described previously.

Process 600 begins with operation 605, where a need to perform an action on personal data is determined. The action on personal data may include sending the personal data to a third party, using the personal data for a service, modifying or deleting a portion of the personal data, or comparable actions. This triggers the evaluation of service policies user preferences compliance. At operation 610, user preferences are received. An application enabling the user to enter their preferences may use a graphical or textual user interface and receive user inputs in any form (text entry, user selection, or similar modes) and convert them into assertions in an extended security assertions language according to embodiments. Processing proceeds to operation 620 from operation 610.

At operation 620, service policies pertaining to user data are received. If a client application is performing the evaluation, the service policies may be received from a server associated with the service. If the service is performing the evaluation, the policies may be retrieved from a service data store. Processing advances to optional operation 630 from operation 620.

At optional operation 630, combined policies are determined if more than one distinct service is involved in handling user personal data as discussed in conjunction with FIG. 2. The combined polices may be used in evaluating whether there is a match with the user preferences. Processing then moves to operation 640.

At operation 640, a match between user preferences and service policies is evaluated for each service using queries based on preference and policy assertions. Processing advances to decision operation 650 from operation 640, where a determination is made whether there is a match or not. If there is no match, processing may be stopped at operation 660 and appropriate fault action taken. For example, user personal data may be stopped from being forwarded to a third party or used for a service. The user may be notified that their preferences cannot be accommodated. Alternatively, other operations such as determination of special circumstances, a request for user acquiescence to the non-matching policy, or a modification of service policy may also be performed upon determination of no match.

If the service policies are determined to comply with user preferences at decision operation 650, the action on personal data may be granted at operation 670. As discussed above, the action may include use, transmittal, modification, deletion, and so on, of the user's personal data. At subsequent operation 680, the action may be performed on the personal data providing the user the requested service (e.g. travel or hotel booking).

The operations included in process 600 are for illustration purposes. User data handling through evaluation of user preference and service policies may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for evaluating user preferences and service policies in handling user data, the method comprising:
receiving a user preference associated with handling of the user data as an assertion in a predefined format;
receiving a service policy corresponding to the received user preference as an assertion in the predefined format; and
determining whether the user preference and the service policy match by evaluating the assertions in form of queries for each service at a data handling module executed by a processor of the computing device.

2. The method of claim 1, further comprising:
enabling a user to define at least one required obligation based on preference assertions; and
enabling a service to define at least one supported obligation and at least one commitment to enforce an obligation based on policy assertions.

3. The method of claim 1, wherein the predefined format is part of a language comprising deductive rules.

4. The method of claim 3, wherein the language enables expression of policy idioms utilizing constraints, controlled delegation, recursive predicates, and negated queries.

5. The method of claim 3, wherein the language further enables expression of statements on user data handling policies to a third party of a separate administrative domain.

6. The method of claim 3, wherein assertions and queries utilizing the language employ verb phrases: “say”, “say0”, and “act as” that are associated with modal verbs: “can”, “may”, “must”, and “will”, each modal verb associated with a data action.

7. The method of claim 6, wherein the data action includes one from a set of: sending the user data to a predefined principal, using the user defined data for a predefined purpose, and deleting the user defined data upon expiration of a predefined duration.

8. The method of claim 6, wherein modal verbs “will” and “must” are employed to express obligations in user preferences and promises in service policies, and wherein modal verbs “may” and “can” are employed to express data-handling permissions in user preferences and to circumscribe possible data treatment in service policies.

9. The method of claim 1, further comprising:
receiving another service policy corresponding to the received user preference from a second service as an assertion in the predefined format;
determining a combined service policy based on merging assertions corresponding to the service policy and the other service policy; and
determining whether the user preference and the combined service policy match by evaluating the assertions in form of queries for each service provided by the second service.

10. A system for providing services to users where user data is handled, the system comprising:
a client device executing a client application acting as a user agent configured to:
enable a user to submit a request for a service;
upon determining a trigger event that include one of: a need to transmit user personal data to a third party and a need to use user personal data, receive the user preference associated with handling of the user personal data;
receive a first service policy corresponding to the received user preference;
receive a second service policy corresponding to the received user preference from a second service configured to provide at least a portion of the requested service;
determine a combined service policy based on merging assertions corresponding to the first and second service policies; and
determine whether the combined service policy complies with the received user preference by evaluating the assertions in form of queries for each service provided by the first and second services;
a first server executing the first service configured to:
if the second service is involved in performing actions associated with the requested service, receive the second service policy;
provide the first and second service policies to the client application acting as user agent;
receive authorization to perform actions on the user personal data if the combined service policy complies with the user preferences; and
perform the actions.

11. The system of claim 10, further comprising a second server configured to execute the second service, wherein the a plurality of user preferences and a plurality of service policies are evaluated with at least a portion of the evaluation being performed by one of the first and second servers.

12. The system of claim 11, wherein the second service is configured to:
provide the second service policies to the first service;
receive authorization to perform actions on the user personal data if the combined service policy complies with the user preferences; and
perform the actions.

13. The system of claim 10, wherein the server is further configured to:
in response to determining at least one non-matching user preference and service policy, terminate further handling of user data, delete existing user data, and notify the user regarding the non-match.

14. The system of claim 10, wherein the server is further configured to:
in response to determining at least one non-matching user preference and service policy, terminate further handling of user data, determine at least one available solution, and notify the user regarding the non-match and the at least one available solution.

15. The system of claim 14, wherein the at least one available solution includes at least one from a set of: modification of a user preference and modification of a service policy.

16. The system of claim 10, wherein the second service policy is combined with the first service policy only if the user preference allows forwarding of user data to other services.

17. A computer-readable storage medium with instructions stored thereon for managing Personally Identifiable Information (PII) associated with a user utilizing a service, the instructions comprising:
in response to a determining a need to perform an action on the user PII, receiving user preferences associated with a particular user PII type to be provided to the service;
receiving service policies corresponding to handling of the particular user PII type by the service, wherein each service to be provided to user is compliant with the service polices; and
determining whether the service policies comply with the received user preferences for the particular user PII type;
if compliance is determined, enabling use of the user PII; else preventing use of the use PII.

18. The computer-readable storage medium of claim 17, wherein:
modal verbs “will” and “must” are employed to express obligations in user preferences and promises in service policies, and
modal verbs “may” and “can” are employed to express data-handling permissions in user preferences and to circumscribe data treatment in service policies.

19. The computer-readable storage medium of claim 17, wherein the action on the user PII includes at least one from a set of: sending the user PII to a third party, processing the user PII for a service, modifying a portion of the user PII, and deleting the user PII.

20. The computer-readable storage medium of claim 17, wherein a security assertion language is used to evaluate the compliance of the service policies with the user preferences employing application-specific verb phrases without built-in semantics to define expressions as parameters, and wherein the expressions include at least one from a set of: principals, PII-types, usage purposes, numbers, and strings.
